(19) United States
(12) Patent Application Publication
(10) Pub. No.: US 2025/0226752 A1
(43) Pub. Date: Jul. 10, 2025

(54) SWITCHING POWER SUPPLY, SELF-POWERED CIRCUIT, AND SELF-POWERED METHOD THEREOF

(71) Applicant: LII SEMICONDUCTOR CO., LTD, Shenzhen (CN)

(72) Inventors: Jie ZHANG, Shenzhen (CN); Lingbo ZHENG, Shenzhen (CN); Fulong WANG, Shenzhen (CN); Xinchun LIN, Shenzhen (CN)

(73) Assignee: LII SEMICONDUCTOR CO., LTD, Shenzhen (CN)

(21) Appl. No.: 19/089,311

(22) Filed: Mar. 25, 2025

Related U.S. Application Data
(63) Continuation of application No. PCT/CN2023/097175, filed on May 30, 2023.

(30) Foreign Application Priority Data
Oct. 27, 2022 (CN) 202211329080.6

(51) Int. Cl. H02M 3/335; H02J 7/00; H02J 7/34; H02M 1/32

(52) U.S. Cl. CPC H02M 3/33507; H02J 7/00714; H02J 7/345; H02M 1/32; H02J 2207/50

(57) ABSTRACT

Disclosed are a switching power supply, and a self-powered circuit and a self-powered method. The self-powered circuit of the switching power supply includes: a charging capacitor for storing power and supplying the power to a switching power supply chip; a voltage-withstanding switch tube for obtaining a power supply voltage of a primary winding and outputting a charging voltage; a charging switch tube for controlling whether to charge the charging capacitor; a current sampler for sampling a charging current of the charging capacitor; an adjustment control tube for limiting the charging current; a current limiting control module for controlling an conduction state of the adjustment control tube; a charging control module preset with charging requirements; and an inverter for obtaining a conduction switch signal and controlling the current limiting control module or the charging control module to be connected to the adjustment control tube.

### CROSS-REFERENCE TO RELATED APPLICATIONS

The present application is a continuation application of International Application No. PCT/CN2023/097175, filed on May 30, 2023, which claims priority to Chinese Patent Application No. 202211329080.6, entitled in “SWITCHING POWER SUPPLY, SELF-POWERED CIRCUIT, AND SELF-POWERED METHOD THEREOF” and filed on Oct. 27, 2022. The disclosures of the above-mentioned applications are incorporated herein by reference in their entireties.

### TECHNICAL FIELD

The present application relates to the technical field of switching power supply control, and in particular to a switching power supply, a self-powered circuit and a self-powered method thereof.

### BACKGROUND

As a type of power conversion device, the flyback switching power supply controls the switching tube to be turned on and off by the switching power supply chip, so as to achieve the energy conversion output of the switch. Since the switching power supply chip itself also needs to consume energy, a self-powered circuit needs to be set up to power the switching power supply chip. The switching power supply working modes are usually divided into continuous conduction mode (CCM) and discontinuous conduction mode (DCM).

Existing self-powered circuits of switching power supplies are usually designed according to the working mode of the switching power supply, but the working mode of the switching power supply is determined by the load. During actual use of the switching power supply, there is a situation where the working mode jumps. When the working mode of the switching power supply changes, and when the original self-powered circuit works in DCM mode, the current in the coil is reduced to 0 in each switching cycle, and it jumps to CCM mode. That is, when the coil current has not been reduced to 0 in each switching cycle, the next switching cycle arrives, and it is difficult for the self-powered circuit to realize small current charging. Therefore, it is necessary to provide a self-powered circuit of the switching power supply and method to meet the requirement that when the working mode jumps, the self-powered circuit can still perform small current charging.

### SUMMARY

In order to ensure that the charging capacitor can be charged with a small current when the switching power supply operates in continuous conduction mode or discontinuous conduction mode, the present application provides a switching power supply and a self-powered circuit and a self-powered method thereof.

In a first aspect, the present application provides a self-powered circuit of a switching power supply, which adopts the following technical solution.

A self-powered circuit of a switching power supply, applied to a flyback switching power supply in a continuous conduction mode and a discontinuous conduction mode, includes:
a charging capacitor, configured to store electrical energy and provide the electrical energy to a switching power supply chip;
a voltage-withstanding switch tube, connected between a primary winding and the charging capacitor, and configured for obtaining a supply voltage of the primary winding and outputting a charging voltage for charging the charging capacitor;
a charging switch tube, connected between the charging capacitor and the voltage-withstanding switch tube, and configured to control whether the charging capacitor is charged;
a current sampler, connected in series between the charging switch tube and the voltage-withstanding switch tube, and configured for sampling a charging current of the charging capacitor;
an adjustment control tube, connected between the voltage-withstanding switch tube and a ground, connected in parallel with the charging switch tube and the charging capacitor, and configured to limit the charging current of the charging capacitor;
a current limiting control module, provided with an input end connected to the current sampler for obtaining the charging current of the charging capacitor, and an output end coupled to a control electrode of the adjustment control tube for controlling a conduction state of the adjustment control tube according to the charging current;
a charging control module, preset with a charging requirement and outputting a conduction switch signal for controlling whether the adjustment control tube is turned on; and
an inverter, coupled between the current limiting control module and the charging control module, and configured to obtain the conduction switch signal and control the current limiting control module or the charging control module to be connected to the adjustment control tube according to the conduction switch signal.

By adopting the above technical solution, the high voltage resistance performance of the voltage-withstanding switch tube enables the charging capacitor to be connected to the primary winding, so that the charging capacitor draws power from the primary winding, thereby ensuring that the charging of the charging capacitor is not affected by the load; by setting a current limiting control module to detect the charging current of the charging capacitor, thereby ensuring that the charging capacitor is charged with a small current; by controlling the conduction of the adjustment control tube through the charging control module, thereby ensuring the energy storage of the primary winding, and at the same time by setting an inverter, under the action of the inverter, ensuring that the adjustment control tube cannot be controlled by the charging control module and the current limiting control module at the same time, thereby ensuring that the charging capacitor replenishment and the primary winding energy storage will not affect each other, which will cause the switching power supply to fail to operate normally.

In a second aspect, the present application provides a switching power supply applied to the above-mentioned self-powered circuit of the switching power supply, adopting the following technical solution.

A switching power supply using the self-powered circuit of the switching power supply includes: a transformer, a control module and a self-powered circuit;
the transformer includes a primary winding and a secondary winding;
the control module includes a switching power supply chip for outputting a control signal; and
the self-powered circuit includes a charging capacitor for powering, a charging switch tube and a charging control module both for controlling whether the charging capacitor is charged, and a current limiting control module for limiting the charging current of the charging capacitor.

In a third aspect, the present application provides a self-powered method for a self-powered circuit based on the above-mentioned switching power supply, adopting the following technical solution.

A self-powered method based on the self-powered circuit of the switching power supply includes:
obtaining the control signal of the switching power supply chip;
determining whether the control signal is at a high-level; in response to that the control signal is at a high-level, performing the following steps; in response to that the control signal is not at a high-level, re-obtaining the control signal;
determining whether the charging circuit is turned on; in response to that the charging circuit is turned on, charging the charging capacitor and performing the following steps; in response to that the charging circuit is not turned on, stopping charging the charging capacitor; and
obtaining the charging current and determining whether the charging current is greater than a preset current reference value; in response to that the charging current is greater than the preset current reference value, the analog voltage signal being greater than an adjustment control tube opening value to pull down the charging voltage; in response to that the charging current is less than or equal to the preset current reference value, the analog voltage signal being a low-level signal.

### BRIEF DESCRIPTION OF THE DRAWINGS

FIG. 1 is a schematic diagram of a partial circuit structure of a switching power supply according to an embodiment of the present application.

FIG. 2 is a schematic diagram of the structure of the self-powered circuit of the switching power supply according to an embodiment of the present application, mainly showing the specific circuit structure of the charging control module as a delay device.

FIG. 3 is a waveform diagram of the switching power supply according to an embodiment of the present application, mainly showing a waveform diagram of a charging control module as a delay device.

FIG. 4 is a schematic diagram of the structure of the self-powered circuit of the switching power supply according to an embodiment of the present application, mainly showing a circuit block diagram of the charging control module as a delay device and a voltage sampler.

FIG. 5 is a schematic diagram of the structure of the self-powered circuit of the switching power supply according to an embodiment of the present application, mainly showing the circuit structure of the charging control module as a delay device and a voltage sampler.

FIG. 6 is a waveform diagram of the switching power supply according to an embodiment of the present application, mainly showing a waveform diagram of the charging control module as a delay device and a voltage sampler.

FIG. 7 is a partial flow chart of a self-powered method for the switching power supply according to an embodiment of the present application.

FIG. 8 is a partial flow chart of the self-powered method of the switching power supply according to an embodiment of the present application, mainly showing a flow chart when the charging requirement is the charging time.

FIG. 9 is a partial flow chart of the self-powered method of the switching power supply according to an embodiment of the present application, mainly showing a flow chart when the charging requirements are the charging time and the charging voltage of the charging capacitor.

### DETAILED DESCRIPTION OF THE EMBODIMENTS

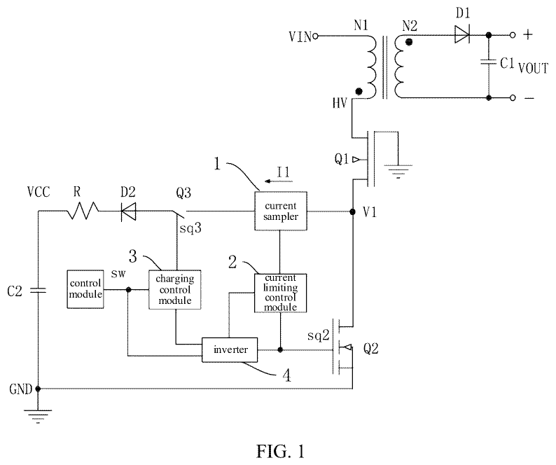

The present application is further described in detail below in conjunction with FIGS. 1-9.

Referring to FIG. 1, a switching power supply is disclosed in the present application, working in continuous conduction mode and discontinuous conduction mode, and the switching power supply includes a transformer, a self-powered circuit and a control module. Among them, the transformer includes a primary winding N1, a secondary winding N2 and an output capacitor C1 connected in parallel to both ends of the secondary winding N2, and the two ends of the output capacitor C1 are configured to be connected to the load; a unidirectional current limiting tube D1 is provided between the output capacitor C1 and the secondary winding N2, and the unidirectional current limiting tube D1 is a diode. The anode of the unidirectional current limiting tube D1 is connected to the secondary winding N2, and its cathode is connected to the positive output end of the output capacitor C1 to prevent the output capacitor C1 from supplying power to the load while also supplying energy to the secondary winding N2. The primary winding N1 and the secondary winding N2 are mutually coupled and induced; when the primary winding N1 is turned on, the primary winding N1 stores energy; the secondary winding N2 does not work, and the output capacitor C1 supplies power to the load. One end of the primary winding N1 is configured to receive the power supply voltage VIN rectified by the rectifier, and the other end of the primary winding N1 is connected to the self-powered circuit. When the primary winding N1 is turned on, the self-powered circuit draws power from the primary winding N1. The control module includes a switching power supply chip and its peripheral circuits, which are configured to output a control signal sw to control the self-powered circuit to charge, and the control signal sw is configured to adjust and control the output voltage of the switching power supply.

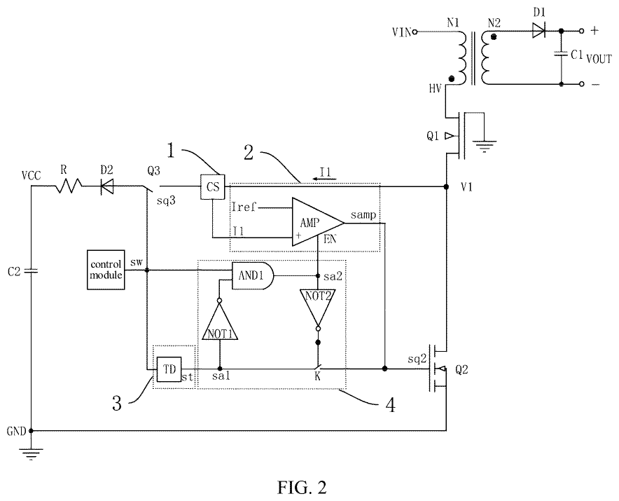

Referring to FIGS. 1 and 2, the self-powered circuit includes:
the charging capacitor C2, configured to store electric energy and provide electric energy to the control module;
the voltage-withstanding switch tube Q1, connected between the primary winding N1 and the charging capacitor C2, and configured to obtain the supply voltage of the primary winding N1 and output a charging voltage V1 for charging the charging capacitor C2;
the charging switch tube Q3, connected between the charging capacitor C2 and the voltage-withstanding switch tube Q1, and configured to control whether the charging capacitor C2 is charged;
the current sampler 1, connected in series between the charging switch tube Q3 and the voltage-withstanding switch tube Q1, and configured to sample the charging current I1 of the charging capacitor C2;
the adjustment control tube Q2, connected between the voltage-withstanding switch tube Q1 and the ground, and connected in parallel with the charging switch tube Q3 and the charging capacitor C2, so as to limit the charging current I1 of the charging capacitor C2;
the current limiting control module 2, provided with an input end connected to the current sampler 1 for obtaining the charging current I1 of the charging capacitor C2, and an output end coupled to the control electrode of the adjustment control tube Q2 for controlling the conduction state of the adjustment control tube Q2 according to the charging current I1;
the charging control module 3, preset with a charging requirement and outputs a conduction switch signal sa1 for controlling whether the regulating control tube Q2 is turned on.

In an embodiment, referring to FIG. 1 and FIG. 2, the primary winding N1, the voltage-withstanding switch tube Q1, the charging switch tube Q3 and the charging capacitor C2 constitute a charging circuit. And in order to prevent the source of the voltage-withstanding switch tube Q1 from being pulled down and causing the charging capacitor C2 to discharge to the ground when both the charging switch tube Q3 and the adjustment control tube Q2 are turned on, a unidirectional conduction tube D2 is connected in series between the charging switch tube Q3 and the charging capacitor C2. When the current flows from the charging switch tube Q3 to the charging capacitor C2, the unidirectional conduction tube D2 is turned on, and vice versa, the unidirectional conduction tube D2 is turned off. In the embodiment of the present application, the unidirectional conduction tube D2 adopts a diode, and the anode of the diode is connected to the charging switch tube Q3, and the cathode of the diode is connected to the charging capacitor C2. A protective resistor R is connected in series between the charging capacitor C2 and the charging switch tube Q3, which is configured to limit the charging current I1 of the charging capacitor C2 to prevent the charging circuit from short-circuiting.

The control electrode of the charging switch tube Q3 is connected to the output end of the control module and is controlled by the control signal sw output by the control module. In the embodiment of the present application, the voltage-withstanding switch tube Q1 adopts a depletion-type gallium nitride transistor, which is in the conduction state under normal conditions. Its working characteristic of taking power from the source end is configured to ensure that the chip only works in a low voltage state. The drain of the voltage-withstanding switch tube Q1 is connected to the primary winding N1, and the gate of the voltage-withstanding switch tube Q1 is grounded; when the control signal sw output by the control module is at a high-level, the charging switch tube Q3 is turned on. In the embodiment of the present application, the charging switch tube Q3 adopts a high-level conduction switch tube, which is not limited to MOS tubes, triodes and other switch tubes. When the charging switch tube Q3 is turned on, whether the source of the voltage-withstanding switch tube Q1 is grounded determines whether the charging circuit is turned on.

The current limiting control module 2 is preset with a current reference value Iref, and compares the charging current I1 with the preset current reference value Iref. When the charging current I1 is greater than the current reference value Iref, the current limiting control module 2 controls the conduction state of the adjustment control tube Q2, and pulls down the charging voltage V1 of the charging capacitor C2, thereby reducing the charging current I1 of the charging capacitor, and ensuring that the charging current I1 is less than or equal to the current reference value Iref. When the control signal sw output by the control module is at a high-level, the charging switch tube Q3 is turned on, the charging capacitor C2 starts to charge, and the current sampler 1 detects the charging current of the charging loop and outputs it to the current limiting control module 2. When the current limiting control module 2 detects that the charging current I1 is greater than the preset current reference value Iref, the current limiting control module 2 outputs an analog voltage signal samp. The analog voltage signal samp is greater than the turn-on voltage of the adjustment control tube Q2, so that the adjustment control tube Q2 is turned on as an adjustment tube, and the source voltage of the voltage-withstanding switch tube Q1 is pulled down. The current limiting control module 2 and the adjustment control tube Q2 are connected to form a negative feedback loop, and finally the charging current I1 of the stable charging loop is less than or equal to the current reference value Iref, so that the charging capacitor C2 is charged at a charging current I1 less than the current reference value Iref.

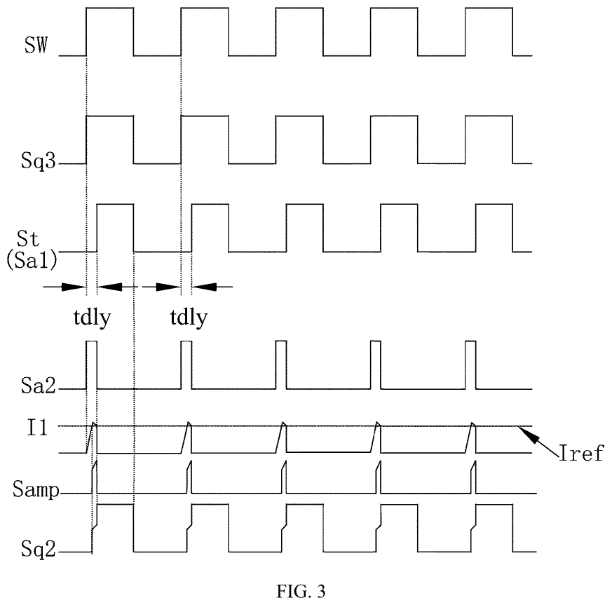

In an embodiment, referring to FIG. 2 and FIG. 3, the current limiting control module 2 includes an operational amplifier AMP and a preset reference circuit. The preset reference circuit is coupled to an input end of the operational amplifier AMP to provide a preset current reference value Iref. The other input end of the operational amplifier AMP is connected to the output end of the current sampler 1 to obtain the charging current I1. The operational amplifier AMP compares the charging current I1 with the preset current reference value Iref and outputs an analog voltage signal samp. The enable end EN of the operational amplifier AMP is coupled to the control module to receive the control signal sw. When the enable end EN receives a high-level signal, the operational amplifier AMP works normally and outputs the analog voltage signal samp. When the enable end EN receives a low-level signal, the operational amplifier AMP outputs a suspended state. In the embodiment of the present application, the preset reference circuit is connected to the reverse input end of the operational amplifier AMP. When the charging current I1 is greater than the preset current reference value Iref, the analog voltage signal samp output by the operational amplifier AMP is a high-level. In the embodiment of the present application, the higher the charging current I1 of the charging circuit is relative to the preset current reference value Iref, the higher the analog voltage signal samp is.

Referring to FIG. 2 and FIG. 3, when the enable end EN receives a high-level signal, if the charging current I1 is less than the preset current reference value Iref, the analog voltage signal samp output by the operational amplifier AMP is low; the adjustment control tube Q2 remains cut off, the charging circuit is turned on, and the charging capacitor C2 is charged; if the charging current I1 is greater than the preset current reference value Iref, the analog voltage signal samp output by the operational amplifier AMP is an analog signal greater than the turn-on voltage of the adjustment control tube Q2; the adjustment control tube Q2 pulls down the charging current, and the operational amplifier AMP is connected to the adjustment control tube Q2 to form a negative feedback loop, so that when the enable end EN receives a high-level signal, the charging current I1 of the charging circuit remains less than or equal to the preset current reference value Iref, ensuring that the charging capacitor C2 is charged with a current less than the preset current reference value Iref. In the embodiment of the present application, the preset current reference value is set according to the working current required by the control module.

Referring to FIG. 2 and FIG. 3, when the control signal sw output by the control module is at a high-level, the primary winding N1 stores energy. When the charging circuit is turned on and the charging capacitor C2 is charged, the primary winding N1 also stores energy. However, since the charging capacitor C2 is charging, the energy storage of the primary winding N1 is affected. To ensure that the primary winding N1 can store energy normally during the switching cycle, the charging control module 3 is preset with charging requirements. When the charging capacitor C2 reaches the charging requirements, the conduction switch signal sa1 output by the charging control module 3 is at a high-level, so that the adjustment control tube Q2 is turned on. When the adjustment control tube Q2 is turned on, the source of the voltage-withstanding switch tube Q1 is pulled down to ground, the charging circuit is disconnected, and the charging capacitor C2 stops charging. At this time, the primary loop is turned on, and the primary winding N1 stores energy.

Referring to FIG. 2 and FIG. 3, in order to prevent the charging control module 3 and the current limiting control module 2 from interfering with each other when controlling the adjustment control tube Q2, an inverter 4 is provided between the charging control module 3 and the current limiting control module 2, and the inverter 4 includes a first AND gate AND1, a first NOT gate NOT1, a second NOT gate NOT2 and a switch tube K. Among them:

an input end of the first NOT gate NOT1 is coupled to an output end of the charging control module 3, and is configured to obtain a conduction switch signal sa1 output by the charging control module 3;

one input end of the first AND gate AND1 is connected to the output end of the first NOT gate NOT1; the other input end thereof is connected to the control module, and the output end thereof is connected to the enable end EN of the operational amplifier AMP, for outputting an enable control signal sa2. When the enable control signal sa2 output by the first AND gate AND1 is at a high-level, the operational amplifier AMP works normally. When the enable control signal sa2 output by the first AND gate AND1 is at a low-level, the operational amplifier AMP is in a suspended state.

The input end of the second NOT gate NOT2 is connected to the output end of the first AND gate AND1, and the output end thereof is coupled to the control electrode of the switch tube K. The switch tube K is a high-level conduction switch tube, which is not limited to MOS tubes, triodes and other switch tubes.

In an embodiment, referring to FIGS. 2 and 3, when the control signal sw output by the control module is at a high-level, the charging switch tube Q3 is turned on. At this time, if the conduction switch signal sa1 output by the charging control module 3 is at a low-level, the conduction switch signal sa1 is converted to a high-level through the action of the first NOT gate NOT1. At this time, both input ends of the first AND gate AND1 are high-level inputs, and the enable control signal sa2 output by the first AND gate AND1 is at a high-level, so that the operational amplifier AMP works normally; the high-level signal output by the first AND gate AND1 is converted to a low-level again under the action of the second NOT gate NOT2, so that the switch tube K is turned off; the analog voltage signal samp output by the operational amplifier AMP controls the control electrode of the adjustment control tube Q2; the charging circuit is always turned on, and the charging capacitor C2 is continuously charged.

Referring to FIG. 2 and FIG. 3, if the conduction switch signal sa1 output by the charging control module 3 is at a high-level, the conduction switch signal sa1 is changed to low-level under the action of the first NOT gate NOT1. Since one input end of the first NOT gate NOT1 is a low-level input, the enable control signal sa2 output by the first AND gate AND1 is a low-level signal, and the operational amplifier AMP is suspended; the low-level signal output by the first AND gate AND1 is changed to a high-level signal again under the action of the second NOT gate NOT2. At this time, the switch tube K is turned on, and the charging control module 3 outputs the conduction switch signal sa1 to control the control electrode of the adjustment control tube Q2. At this time, the conduction switch signal sa1 is at a high-level, and the adjustment control tube Q2 is turned on; the source of the voltage-withstanding switch tube Q1 is pulled down to ground, and the charging circuit is disconnected; and the charging capacitor C2 stops charging. At this time, the primary loop is turned on, and the primary winding N1 stores energy.

Referring to FIG. 2 and FIG. 3, the charging control module 3 includes a delay device TD, which is provided with a preset time length tdly to ensure that the charging capacitor C2 has enough time to charge. As the charging circuit conduction time increases, the charging current I1 of the charging circuit gradually increases. Under the condition of ensuring the normal operation of the switching power supply, the preset time length tdly is set to the maximum to ensure that the charging capacitor C2 has enough charging time. The input end of the delay device TD is connected to the output end of the control module, and the output end of the delay device TD is connected to the inverter 4 to output the delay signal st. In the embodiment of the present application, the delay signal st is the conduction switch signal sa1. At the same time, the preset time length tdly is a time of the order of hundreds of nanoseconds to ensure that the energy storage of the primary winding N1 of the switching power supply is not affected.

In an embodiment, the delay device TD is triggered by a high-level. When the control signal sw is at a high-level, the delay device TD starts timing. When the preset time length tdly is not reached, the delay device TD maintains a low-level output, and the operational amplifier AMP outputs an analog voltage signal samp to control the control electrode of the adjustment control tube Q2. The charging circuit is always in a conduction state, and the charging capacitor C2 continues to charge; when the timing duration reaches the preset time length tdly, the delay device TD outputs a high-level signal, and through the reverse action of the first NOT gate NOT1, the enable end EN of the operational amplifier AMP inputs a low-level signal, and the operational amplifier AMP outputs a suspended state. At this time, the control electrode of the adjustment control tube Q2 is controlled by the switch conduction signal sa1. When the delay device TD outputs a high-level signal, the adjustment control tube Q2 is turned on to turn on the primary loop. Therefore, in the embodiment of the present application, the adjustment control tube Q2 is also turned on at a high-level. The adjustment control tube Q2 is not limited to switching tubes such as triodes and MOS tubes.

The primary winding N1, the voltage-withstanding switch tube Q1 and the adjustment control tube Q2 constitute a primary loop. In the primary loop, the adjustment control tube Q2 is used as a control tube. When the adjustment control tube Q2 is turned on, the primary loop is turned on. The primary winding N1, the voltage-withstanding switch tube Q1 and the adjustment control tube Q2 constitute a primary loop. When the primary loop is turned on, the primary winding N1 stores energy.

The implementation principle of the self-powered circuit of the switching power supply in an embodiment of the present application is as follows: the switching power supply operates in a continuous conduction mode and a discontinuous conduction mode. When the control module outputs a high-level, the charging switch tube Q3 is turned on; the charging circuit is turned on, and the charging capacitor C2 starts to charge. Within the preset time length tdly, the delay signal st output by the delay device TD is a low-level. At this time, the control electrode of the adjustment control tube Q2 is controlled by the current limiting control module 2. When the charging current I1 of the charging capacitor C2 is less than the preset current reference value Iref, the analog voltage signal samp output by the operational amplifier AMP is a low-level, and the adjustment control tube Q2 does not pull down the charging voltage V1; when the charging current of the charging capacitor C2 is greater than the preset current reference value Iref, the analog voltage signal samp output by the operational amplifier AMP is greater than the turn-on value of the adjustment control tube Q2; the adjustment control tube Q2 is not completely turned on under the action of the analog voltage signal samp, and the adjustment control tube Q2 pulls down the charging voltage V1, so that the charging current I1 of the charging capacitor C2 is less than the preset current reference value Iref.

When the timing duration of the delay device TD reaches the preset time length tdly, the delay signal st output by the delay device TD is at a high-level. At this time, the operational amplifier AMP is in a suspended state, and the control electrode of the adjustment control tube Q2 is controlled by the charging control module 3. The adjustment control tube Q2 is turned on. At this time, although the charging switch tube Q3 is also turned on, the source voltage of the voltage-withstanding switch tube Q1 is pulled down to the ground; the unidirectional conduction tube D2 is reversely cut off, and the charging capacitor C2 stops charging; the primary loop is turned on, and the primary winding N1 stores energy. When the control signal sw output by the control module is at a low-level, the charging switch tube Q3 and the adjustment control tube Q2 are both turned off, and the voltage-withstanding switch tube Q1 is pinched off. At this time, the primary loop is disconnected, and the energy of the primary winding N1 is converted to the secondary winding N2 to power the load.

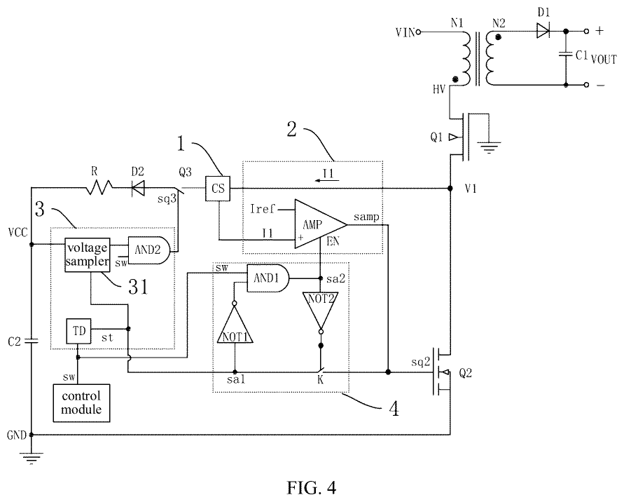

Further, in another embodiment, referring to FIG. 4, the charging control module 3 further includes:

The voltage sampler 31, provided with an input end connected to one end of the charging capacitor C2, and configured to obtain the voltage signal VCC of the charging capacitor C2 and output the judgment signal s1; and an output end thereof coupled to the control electrode of the adjustment control tube Q2, and configured to control the adjustment control tube Q2 to be turned on or off;

The second AND gate AND2, provided with an input end connected to the voltage sampler 31 and the control module respectively, and an output end connected to the control electrode of the charging switch tube Q3, and configured to obtain the judgment signal s1 and the control signal sw, and control whether the charging switch tube Q3 is turned on according to the judgment signal s1 and the control signal sw.

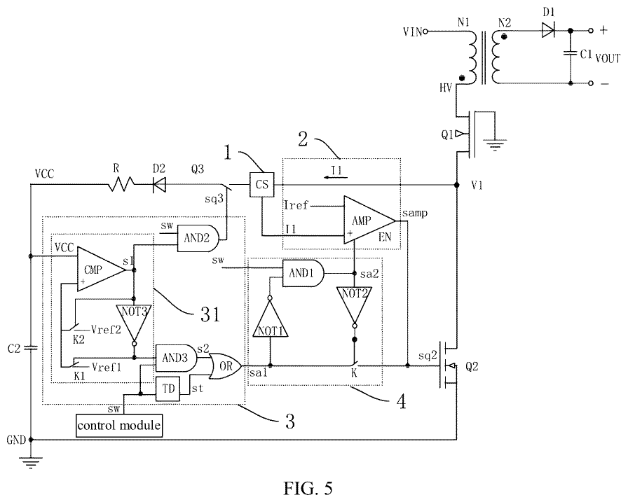

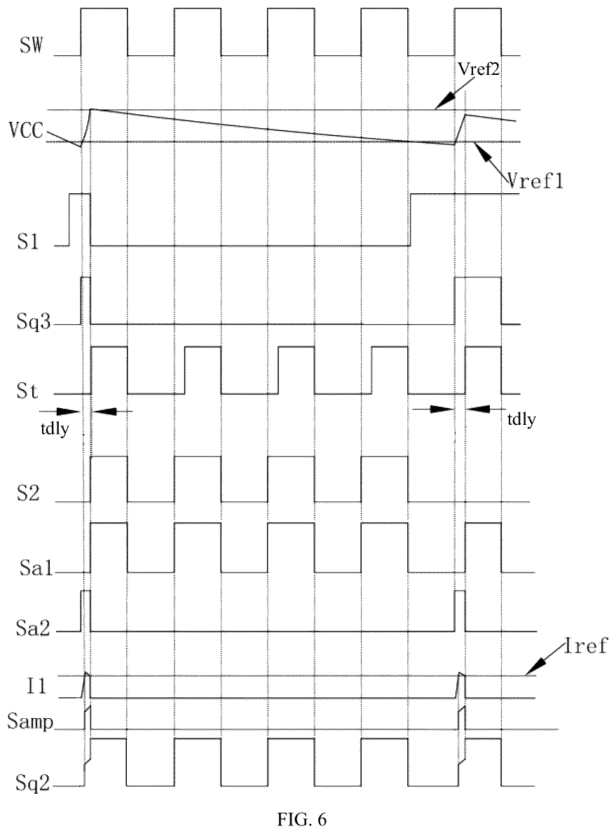

Referring to FIG. 5 and FIG. 6, in order to prevent the charging circuit from being turned on when the charging capacitor C2 is fully charged, the voltage sampler 31 is preset with a low voltage reference value Vref1 and a high voltage reference value Vref2. The voltage value of the low voltage reference value Vref1 is less than the voltage value of the high voltage reference value Vref2. The voltage sampler 31 first compares the voltage signal VCC of the sampled charging capacitor C2 with the low voltage reference value Vref1. When the voltage signal VCC is lower than the low voltage reference value Vref1, the charging capacitor C2 needs to be charged. When the voltage signal VCC of the charging capacitor C2 is higher than the low voltage reference value Vref1, the charging capacitor C2 does not need to be charged. The voltage sampler 31 compares the voltage signal VCC with the high voltage reference value Vref2. When the voltage signal VCC is higher than the high voltage reference value Vref2, the charging capacitor C2 is completely charged. At this time, the voltage sampler 31 compares the voltage signal VCC with the low voltage reference value Vref1 again. When there is no voltage signal VCC of the charging capacitor C2 lower than the low voltage reference value Vref1 during the switching cycle, the voltage sampler 31 outputs a low-level signal, and the second AND gate AND2 outputs a low-level signal. At this time, the charging switch tube Q3 is turned off and the charging circuit is not conducting; when there is a voltage signal VCC of the charging capacitor C2 lower than the low voltage reference value Vref1 during the switching cycle, the voltage sampler 31 outputs a high-level signal, and the output signal of the second AND gate AND2 is controlled by the control signal SW.

Referring to FIG. 5 and FIG. 6, in order to realize the jump between the low voltage reference value Vref1 and the high voltage reference value Vref2, the voltage sampler 31 includes a voltage comparator CMP, a low voltage reference circuit and a high voltage reference circuit arranged at an input end of the voltage comparator CMP; the low voltage reference circuit is configured to provide the low voltage reference value Vref1, and the high voltage reference circuit is configured to provide the high voltage reference value Vref2. In the embodiment of the present application, the low voltage reference circuit and the high voltage reference circuit are connected to the same direction input end of the voltage comparator CMP, and the reverse input end of the voltage comparator CMP is connected to one end of the charging capacitor to obtain the voltage signal. A first conductive element is provided between the output end of the voltage comparator CMP and the low voltage reference circuit, and a second conductive element is provided between the output end of the voltage comparator CMP and the high voltage reference circuit. The conductive structures of the first conductive element and the second conductive element are opposite. In the embodiment of the present application, the first conductive element is shown by taking the first switch K1 and the third NOT gate NOT3 as an example, and the second conductive element is shown by taking the second switch K2 as an example. The first switch K1 and the second switch K2 have the same structure and are both high-level conductive. Similarly, the conduction structures of the first switch K1 and the second switch K2 are opposite. When the conduction structures of the first switch K1 and the second switch K2 are opposite, there is no need for the third NOT gate NOT3. In the embodiment of the present application, it is preferred to take the first switch K1 and the second switch K2 having the same conduction structure as an example for demonstration. The first switch K1 controls whether the low voltage reference circuit is connected to the voltage comparator CMP according to the judgment signal s1 processed by the third NOT gate NOT3, and the second switch K2 controls whether the high voltage reference circuit is connected to the voltage comparator CMP according to the judgment signal s1. Under the action of the third NOT gate NOT3, the low voltage reference circuit and the high voltage reference circuit cannot be connected to the voltage comparator CMP at the same time.

The output end of the voltage comparator CMP is connected to one input end of the second AND gate AND2, and the other input end of the second AND gate AND2 is connected to the control module. When both input ends of the second AND gate AND2 are high-level inputs, the charging switch tube Q3 is turned on, so that the charging circuit is turned on, and the charging capacitor C2 is charged. When one or both input ends of the second AND gate AND2 input a low-level signal, the second AND gate AND2 outputs a low-level signal, and the charging switch tube Q3 is turned off. At this time, the charging circuit is disconnected, and the charging capacitor C2 stops charging.

Referring to FIG. 5 and FIG. 6, a third AND gate AND3 is provided between the voltage comparator CMP and the adjustment control tube Q2; one input end of the third AND gate AND3 is connected to the output end of the third NOT gate NOT3, and the other input end of the third AND gate AND3 is connected to the control module; the output end of the third AND gate AND3 is coupled to the control electrode of the adjustment control tube Q2. When both input ends of the third AND gate AND3 are high-level signals, the adjustment control tube Q2 is controlled by the voltage sampler 31; at this time, the adjustment control tube Q2 is turned on, and the primary loop is turned on; when one or both input ends of the third AND gate AND3 are input with a low-level signal, the third AND gate AND3 outputs a low-level signal, and the adjustment control tube Q2 is not controlled by the voltage sampler 31.

Referring to FIG. 5 and FIG. 6, when the charging capacitor C2 is fully charged, the voltage comparator CMP outputs a judgment signal S1 which is a low-level signal; at this time, the high voltage reference circuit is disconnected from the voltage comparator CMP; and under the action of the third NOT gate NOT3, the voltage comparator CMP is connected to the low voltage reference circuit and obtains the low voltage reference value Vref1; therefore, before the next charging of the charging capacitor C2 begins, the voltage comparator CMP is connected to the low voltage reference circuit. When the charging capacitor C2 needs to be charged, the voltage comparator CMP is disconnected from the low voltage reference circuit and connected to the high voltage reference circuit until the charging capacitor C2 is fully charged. When the control signal sw changes from a low-level to a high-level, and the charging capacitor C2 needs to be charged, the voltage comparator CMP outputs a high-level signal, and the second switch K2 is closed to control the high voltage reference circuit to be connected to the voltage comparator CMP; the first AND gate AND1 outputs a high-level signal, the charging switch tube Q3 is turned on, and the charging capacitor C2 is charged; when the voltage signal VCC sampled by the voltage comparator CMP is higher than the high voltage reference value Vref2, the voltage comparator CMP outputs a low-level signal; at this time, the second switch K2 controls the high voltage reference circuit to be disconnected from the voltage comparator CMP, and the first switch K1 controls the low voltage reference circuit to be connected to the voltage comparator CMP under the action of the third NOT gate NOT3.

Referring to FIG. 5 and FIG. 6, in order to ensure that the primary winding N1 stores energy normally and prevent the charging capacitor C2 from failing to reach the high voltage reference value Vref2, which causes the primary winding N1 to fail to store energy normally, the charging control module 3 further includes an OR logic device OR. Two input ends of the OR logic device OR are respectively connected to the output end of the third AND gate AND3 and the output end of the delay device TD. The output end of the OR logic device OR is coupled to the control electrode of the adjustment control tube Q2. In the embodiment of the present application, the OR logic device OR outputs a conduction switch signal sa1. When either the delay device TD or the third AND gate AND3 outputs a high-level, the adjustment control tube Q2 can be turned on under the action of the OR logic device OR. When the adjustment control tube Q2 is turned on, the primary loop is turned on, and the primary winding N1 stores energy.

The implementation principle of a self-powered circuit of a switching power supply in an embodiment of the present application is as follows: when the control signal sw output by the control module is at a high-level, the delay device TD starts timing, and before the delay device TD reaches a preset time length tdly, the delay signal st output by the delay device TD is at a low-level; if the voltage comparator CMP also outputs a low-level signal, it indicates that the charging capacitor C2 does not need to be charged; and at this time, the charging control module 3 outputs a high-level signal, adjustment control tube Q2 is turned on, and the primary winding N1 stores energy.

If the voltage comparator CMP outputs a high-level signal, it means that the charging capacitor C2 needs to be charged. At this time, the second AND gate AND2 outputs a high-level signal, the charging switch tube Q3 is turned on, and the charging capacitor C2 starts to charge. The voltage comparator CMP obtains the voltage signal VCC of the charging capacitor C2, and compares the voltage signal VCC with the high voltage reference value Vref1. Within the preset time length tdly, when the voltage signal VCC obtained by the voltage comparator CMP is less than the high voltage reference value Vref2, the voltage comparator CMP outputs a high-level signal, and the second AND gate AND2 maintains a high-level output; the charging switch tube Q3 is turned on, and the charging capacitor C2 starts to charge. The input end of the third AND gate AND3 connected to the voltage sampler 31 is a low-level input, so the third AND gate AND3 outputs a low-level signal; the OR logic device OR outputs a low-level signal; the enable pin EN of the operational amplifier AMP inputs a high-level signal; the operational amplifier AMP works normally, and the control electrode of the adjustment control tube Q2 is controlled by the current limiting control module 2. When the charging current I1 of the charging capacitor C2 is lower than the preset current reference value Iref, the analog voltage signal samp output by the operational amplifier AMP is a low-level, and the adjustment control tube Q2 does not pull down the charging voltage V1; when the charging current I1 of the charging capacitor C2 is greater than the preset current reference value Iref, the analog voltage signal samp output by the operational amplifier AMP is a positive value. The adjustment control tube Q2 is in an incomplete conduction state under the action of the analog voltage signal samp, and the adjustment control tube Q2 pulls down the charging voltage V1, so that the charging current I1 of the charging capacitor C2 is not greater than the preset current reference value Iref.

When the timing duration of the delay device TD does not reach the preset time length tdly, if the voltage signal VCC of the charging capacitor C2 sampled by the voltage comparator CMP is higher than the high voltage reference value Vref2, the charging capacitor C2 is fully charged. At this time, the voltage comparator CMP outputs a low-level signal, and the second AND gate AND2 outputs a low-level signal, so that the charging switch tube Q3 is disconnected, and the charging capacitor C2 stops charging; the low voltage reference circuit is connected to the voltage comparator CMP, and the voltage comparator CMP compares the sampled voltage signal VCC of the charging capacitor C2 with the low voltage reference value Vref1; the third AND gate AND3 outputs a high-level signal, the OR logic device OR outputs a high-level signal, and inputs a low-level signal to the enable end EN of the operational amplifier AMP; the operational amplifier AMP is suspended, and the charging control module 3 controls the adjustment control tube Q2 to be turned on; and the source of the voltage-withstanding switch tube Q1 is grounded. At this time, the charging of the charging capacitor C2 stops, so that the primary winding N1 stores energy.

When the timing duration of the delay device TD reaches the preset time length tdly, the delay signal st output by the delay device TD is at a high-level. If the voltage signal VCC of the charging capacitor C2 sampled by the voltage comparator CMP is lower than the high voltage reference value Vref2, the delay device TD outputs a high-level signal; and the OR logic device OR outputs a high-level signal, and inputs a low-level signal to the enable end EN of the operational amplifier AMP. The operational amplifier AMP is suspended. The charging control module 3 controls the adjustment control tube Q2 to turn on, and the source of the voltage-withstanding switch tube Q1 is grounded. At this time, the charging capacitor C2 stops charging to store energy in the primary winding N1.

When the control signal sw output by the control module is at a low-level, the second AND gate AND2 outputs a low-level signal; the charging switch tube Q3 is turned off; the third AND gate AND3 outputs a low-level signal; the OR logic device OR outputs a low-level signal, and the adjustment control tube Q2 is turned off. At this time, the primary loop is disconnected, and the secondary winding N2 supplies power to the load.

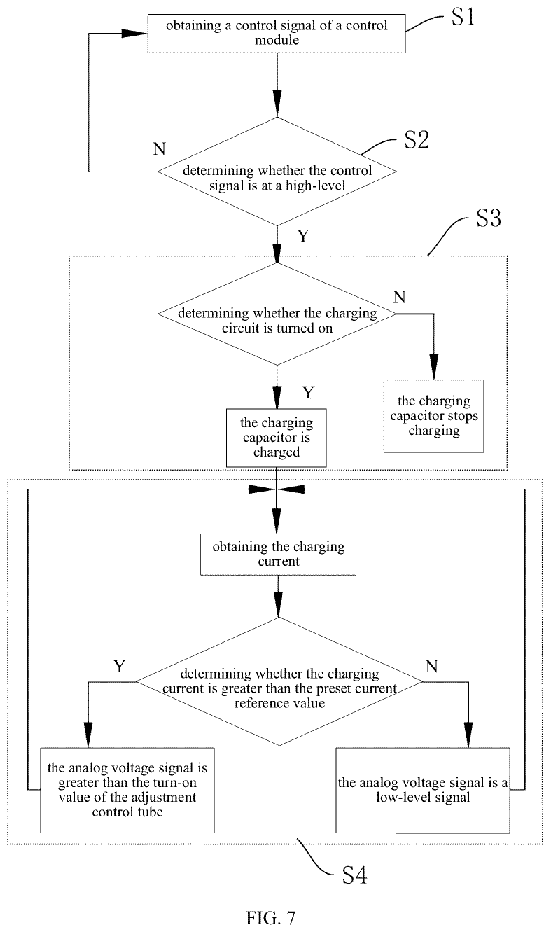

The embodiment of the present application also discloses a self-powered method for a switching power supply. Referring to FIG. 7, the self-powered method includes the following steps.

S1. obtaining a control signal sw of a control module.

In an embodiment, the control module outputs the control signal sw to control whether the charging switch tube Q3 is turned on. When the control signal sw is at a low-level, the charging switch tube Q3 is turned off. When the control signal sw is at a high-level, the charging switch tube Q3 may be turned on.

S2. determining whether the control signal sw is at a high-level; if so, executing the following steps; if not, reobtaining the control signal sw.

S3. determining whether the charging circuit is turned on; if so, the charging capacitor C2 is charged and the following steps are performed; if not, the charging capacitor C2 stops charging.

In an embodiment, when the control signal sw output by the control module is at a low-level, the voltage-withstanding switch tube Q1 is not turned on, and the charging capacitor C2 is not charged. When the control signal sw is at a high-level, the charging capacitor C2 is charged or not charged according to the charging requirement. When the control signal sw output by the control module is at a high-level, the charging circuit may be turned on or off. When the charging circuit is turned on, the charging capacitor C2 is charged; when the charging circuit is turned off, the charging capacitor C2 stops charging.

S4, obtaining the charging current I1, and determining whether the charging current I1 is greater than the preset current reference value Iref; if so, the analog voltage signal samp is greater than the turn-on value of the adjustment control tube Q2 to pull down the charging voltage V1, if not, the analog voltage signal is a low-level signal.

In an embodiment, the operational amplifier AMP and the adjustment control tube Q2 form a negative feedback loop. One input end of the operational amplifier AMP presets the current reference value Iref, and the other input end of the operational amplifier AMP receives the charging current I1 sampled and detected by the current sampler 1. The operational amplifier AMP compares the charging current I1 with the preset current reference value Iref and outputs an analog voltage signal samp; when the charging current I1 is less than or equal to the preset current reference value Iref, the analog voltage signal samp output by the operational amplifier AMP is a low-level signal, and the adjustment control tube Q2 remains cut off at this time; when the charging current I1 is greater than the preset current reference value Iref, the analog voltage signal samp output by the operational amplifier AMP is greater than the turn-on value of the adjustment tube Q2; the adjustment control tube Q2 is in an incomplete conduction state under the action of the analog voltage signal samp, and the adjustment control tube Q2 pulls down the charging voltage V1, so that the charging current I1 of the charging capacitor C2 is not higher than the preset current reference value Iref. During the charging process of the charging capacitor C2, the operational amplifier AMP continuously obtains the charging current I1 and compares the charging current I1 with a preset current reference value Iref.

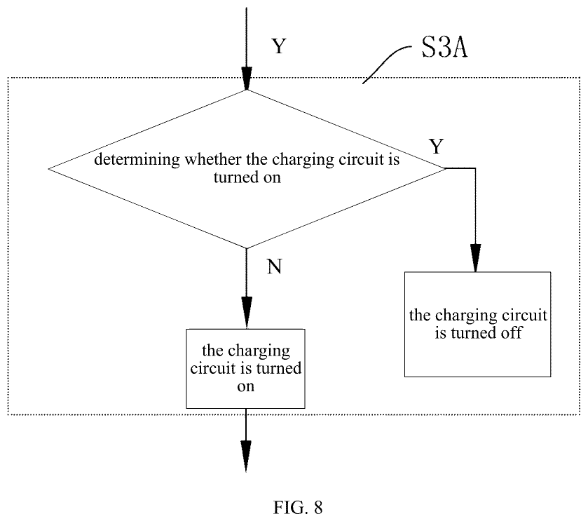

In an embodiment, referring to FIG. 7 and FIG. 8, determining whether the charging circuit is turned on includes the following steps:

S3A, determining whether the conduction time of the charging circuit reaches the preset time length tdly; if not, the charging circuit is turned on; if so, the charging circuit is turned off. In an embodiment, the delay device TD is preset with a preset time length tdly, that is, the charging requirement of the charging capacitor C2 is the charging duration. When the control signal sw is at a high-level, the delay device TD starts timing. When the control signal sw output by the control module is at a high-level, the charging switch tube Q3 is turned on; the charging circuit is turned on; the charging capacitor C2 is charged, and the delay device TD starts timing. When the timing duration reaches the preset time length tdly, the adjustment control tube Q2 is turned on; the source of the voltage-withstanding switch tube Q1 is grounded, and the charging circuit is disconnected, so that the charging capacitor C2 stops charging. At this time, the primary loop is turned on, and the primary winding N1 stores energy until the control signal sw jumps from a high-level to a low-level, and the charging circuit and the primary loop are both disconnected. At this time, the secondary winding N2 supplies power to the load.

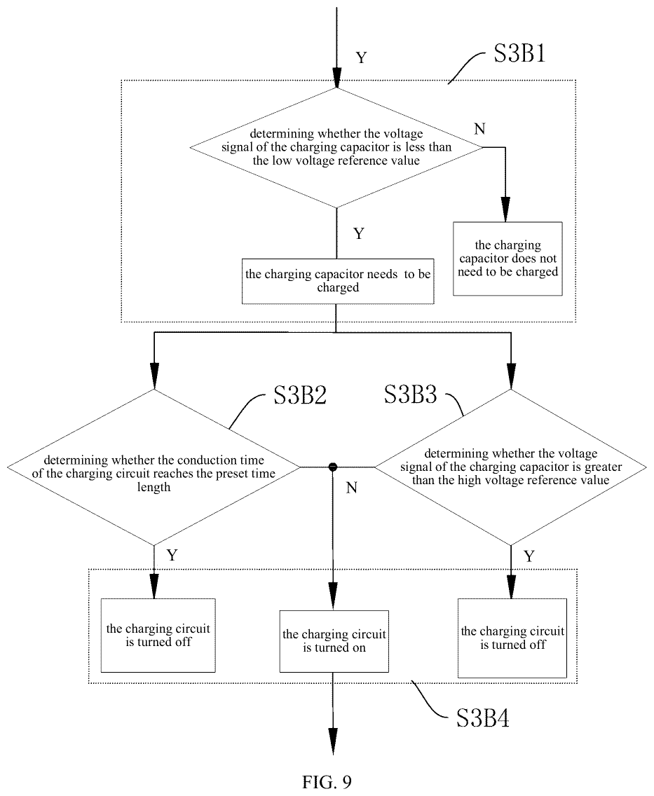

In another embodiment, referring to FIG. 7 and FIG. 9, determining whether the charging circuit is turned on includes the following steps:
S3B1, determining whether the voltage signal VCC of the charging capacitor C2 is less than the low voltage reference value Vref1, if so, the charging capacitor C2 is charged and the following steps are performed, if not, the charging capacitor C2 does not need to be charged;
S3B2, determining whether the conduction time of the charging circuit reaches the preset time length tdly;
S3B3, determine whether the voltage signal VCC of the charging capacitor C2 is greater than the high voltage reference value Vref2;
S3B4. If the above judgment results are all no, the charging circuit is turned on; if any judgment result is yes, the charging circuit is turned off.

In an embodiment, the voltage sampler 31 samples and detects the voltage signal VCC of the charging capacitor C2, and compares the sampled voltage signal VCC with its preset low voltage reference value or high voltage reference value. In a switching cycle, it is first determined whether the charging capacitor C2 needs to be charged, that is, the voltage comparator CMP compares the voltage signal VCC of the sampled charging capacitor C2 with the low voltage reference value Vref1. When the voltage signal VCC is higher than the low voltage reference value Vref1, the charging capacitor C2 does not need to be charged; when the voltage signal VCC is lower than the low voltage reference value Vref1, the charging capacitor C2 needs to be charged. When the charging capacitor C2 does not need to be charged, when the control signal sw is at a high-level, the charging circuit remains disconnected; when the charging capacitor C2 needs to be charged, when the control signal sw is at a high-level, the charging circuit is turned on, and the charging capacitor C2 is charged. When the charging capacitor C2 meets the charging requirements, the charging circuit is disconnected; the charging capacitor C2 stops charging, and the primary winding N1 stores energy.

When the sampled voltage signal VCC of the charging capacitor C2 is lower than the low voltage reference value Vref1, the voltage sampler 31 is connected to the voltage comparator CMP from the low voltage reference circuit to the high voltage reference circuit under the action of the third NOT gate NOT3. At this time, the voltage comparator CMP compares the sampled voltage signal VCC of the charging capacitor C2 with the high voltage reference value Vref2. When the control signal sw is at a high-level, the charging switch tube Q3 is turned on, and the charging capacitor C2 starts to charge. The delay timer TD starts timing.

When the timing duration of the delay device TD does not reach the preset time length tdly, if the voltage signal VCC of the sampled charging capacitor C2 is higher than the high voltage reference value Vref2, it means that the charging capacitor C2 is fully charged. At this time, the voltage sampler 31 compares the voltage signal VCC with the low voltage reference value Vref1 again, the charging switch tube Q3 is disconnected, and the charging circuit is disconnected; the charging capacitor C2 stops charging, and the adjustment control tube Q2 is turned on; the primary loop is turned on, and the primary winding N1 stores energy.

When the timing duration of the delay device TD reaches the preset time length tdly, if the voltage signal VCC of the sampled charging capacitor C2 is lower than the high voltage reference value Vref2, the delay device TD outputs a high-level signal and inputs a low-level signal to the enable end EN of the operational amplifier AMP. At this time, the operational amplifier AMP is suspended, the charging control module 3 controls the adjustment control tube Q2 to turn on, the source of the voltage-withstanding switch tube Q1 is grounded, and the charging capacitor C2 stops charging to store energy in the primary winding N1.

The embodiment of the present application also discloses a self-powered chip of a switching power supply, in which the self-powered circuit of the switching power supply disclosed in the above embodiment is integrated, including a charging capacitor C2, a voltage-withstanding switch tube Q1, a charging switch tube Q3, an adjustment control tube Q2, a current limiting control module 2 and a charging control module 3, so that the charging capacitor C2 draws power from the primary winding N1, and charges the charging capacitor C2 with a small current during the switching cycle. The self-powered chip is suitable for a flyback switching power supply, using a gallium nitride consumption tube as a voltage-withstanding switch tube Q1, and using its working characteristics to draw power from the source end, ensuring that the self-powered chip only works in a low voltage state, reducing the complexity of the chip and reducing the voltage-withstanding requirements of the internal components of the chip. The voltage-withstanding switch tube Q1 and the charging capacitor C2 can not only be integrated into the self-powered chip of the switching power supply, but can also be independently set outside the self-powered chip of the switching power supply.

The embodiments of the specific implementation methods of the present application are all some embodiments of the present application, and are not intended to limit the protection scope of the present application. Therefore, all equivalent changes made based on the structure, shape, and principle of the present application should be included in the protection scope of the present application.

What is claimed is:

1. A self-powered circuit of a switching power supply, applied to a flyback switching power supply in a continuous conduction mode and a discontinuous conduction mode, comprising:
a charging capacitor, configured to store electrical energy and provide the electrical energy to a switching power supply chip;
a voltage-withstanding switch tube, connected between a primary winding and the charging capacitor, and configured for obtaining a supply voltage of the primary winding and outputting a charging voltage for charging the charging capacitor;
a charging switch tube, connected between the charging capacitor and the voltage-withstanding switch tube, and configured to control whether the charging capacitor is charged;
a current sampler, connected in series between the charging switch tube and the voltage-withstanding switch tube, and configured for sampling a charging current of the charging capacitor;
an adjustment control tube, connected between the voltage-withstanding switch tube and a ground, connected in parallel with the charging switch tube and the charging capacitor, and configured to limit the charging current of the charging capacitor;
a current limiting control module, provided with an input end connected to the current sampler for obtaining the charging current of the charging capacitor, and an output end coupled to a control electrode of the adjustment control tube for controlling a conduction state of the adjustment control tube according to the charging current;
a charging control module, preset with a charging requirement and outputting a conduction switch signal for controlling whether the adjustment control tube is turned on; and
an inverter, coupled between the current limiting control module and the charging control module, and configured to obtain the conduction switch signal and control the current limiting control module or the charging control module to be connected to the adjustment control tube according to the conduction switch signal.

2. The self-powered circuit of the switching power supply according to claim 1, wherein a unidirectional conduction tube and a protection resistor are connected in series between the charging capacitor and the charging switch tube;
the unidirectional conduction tube is configured to realize unidirectional conduction of current from the charging switch tube to the charging capacitor; and
the protection resistor is configured to limit the charging current of the charging capacitor.

3. The self-powered circuit of the switching power supply according to claim 1, wherein the current limiting control module comprises:
a preset reference circuit configured for providing a preset current reference value; and
an operational amplifier configured for receiving the charging current sampled by the current sampler, comparing the charging current with the preset current reference value, and outputting an analog voltage signal;
wherein an enable end of the operational amplifier is connected to the inverter, and the inverter is configured to control whether the operational amplifier works normally; an output end of the operational amplifier is connected to the control electrode of the adjustment control tube, and the analog voltage signal is configured to control whether the adjustment control tube is turned on.

4. The self-powered circuit of the switching power supply according to claim 3, wherein the inverter comprises a first AND gate, a first NOT gate, a second NOT gate and a switch tube;
an input end of the first NOT gate is coupled to an output end of the charging control module and is configured to obtain the conduction switch signal output by the charging control module;
an input end of the first AND gate is connected to the switching power supply chip and an output end of the first NOT gate respectively, and an output end of the first AND gate is connected to the enable end of the operational amplifier to control whether the operational amplifier works normally;
an input end of the second NOT gate is connected to the output end of the first AND gate, and an output end of the second NOT gate is connected to the output switch tube, so as to control the switch tube to be turned on or off; and
the switch tube is configured to control whether the charging control module is connected to the adjustment control tube.

5. The self-powered circuit of the switching power supply according to claim 3, wherein the charging control module comprises a delay device, and the delay device is provided with a preset time length; the delay device is coupled between the switching power supply chip and the inverter, and is configured to delay an output control signal.

6. The self-powered circuit of the switching power supply according to claim 5, wherein the charging control module further comprises:
a voltage sampler, configured to obtain a voltage signal of the charging capacitor and output a judgment signal for controlling the adjustment control tube to be turned on or off; and
a second AND gate, provided with an input end connected to the voltage sampler and the switching power supply chip respectively, and an output end connected to the control electrode of the charging switch tube, and configured to obtain the judgment signal and the control signal, and control whether the charging switch tube is turned on according to the judgment signal and the control signal.

7. The self-powered circuit of the switching power supply according to claim 6, wherein the voltage sampler comprises a voltage comparator, a low voltage reference circuit and a high voltage reference circuit; the low voltage reference circuit and the high voltage reference circuit are connected to an input end of the voltage comparator; the low voltage reference circuit is configured to provide a low voltage reference value, and the high voltage reference circuit is configured to provide a high voltage reference value; the high voltage reference value is greater than the low voltage reference value; and
a first conductive element is provided between an output end of the voltage comparator and the low voltage reference circuit, and a second conductive element is provided between the output end of the voltage comparator and the high voltage reference circuit; conductive structures of the first conductive element and the second conductive element are opposite.

8. The self-powered circuit of the switching power supply according to claim 6, wherein the charging control module further comprises:
a third AND gate, connected between the voltage sampler and the adjustment control tube, wherein an input end of the third AND gate is respectively connected to the voltage sampler and the switching power supply chip, and an output end of the third AND gate is coupled to the adjustment control tube; and
an OR logic device, wherein an input end of the OR logic device is respectively connected to the third AND gate and the delay device, and an output end of the OR logic device is connected to the inverter.

9. A switching power supply using the self-powered circuit of the switching power supply according to claim 1, comprising: a transformer, a control module and a self-powered circuit;
wherein the transformer comprises a primary winding and a secondary winding;
the control module comprises a switching power supply chip for outputting a control signal; and
the self-powered circuit comprises a charging capacitor for powering, a charging switch tube and a charging control module both for controlling whether the charging capacitor is charged, and a current limiting control module for limiting the charging current of the charging capacitor.

10. A self-powered method based on the self-powered circuit of the switching power supply according to claim 1, comprising:
obtaining the control signal of the switching power supply chip;
determining whether the control signal is at a high-level; in response to that the control signal is at a high-level, performing the following steps; in response to that the control signal is not at a high-level, re-obtaining the control signal;
determining whether the charging circuit is turned on; in response to that the charging circuit is turned on, charging the charging capacitor and performing the following steps; in response to that the charging circuit is not turned on, stopping charging the charging capacitor; and
obtaining the charging current and determining whether the charging current is greater than a preset current reference value; in response to that the charging current is greater than the preset current reference value, the analog voltage signal being greater than an adjustment control tube opening value to pull down the charging voltage; in response to that the charging current is less than or equal to the preset current reference value, the analog voltage signal being a low-level signal.

11. The self-powered method according to claim 10, wherein the determining whether the charging circuit is turned on comprises:
determining whether a conduction time of the charging circuit reaches a preset time; if not, the charging circuit is on; if so, the charging circuit is off.

12. The self-powered method according to claim 10, wherein the determining whether the charging circuit is turned on comprises:
determining whether the voltage signal of the charging capacitor is less than the low voltage reference value; in response to that the voltage signal of the charging capacitor is less than the low voltage reference value, charging the charging capacitor and performing the following steps; in response to that the voltage signal of the charging capacitor is greater than or equal to the low voltage reference value, not charging the charging capacitor;
determining whether the conduction time of the charging circuit reaches a preset time;
determining whether the voltage signal of the charging capacitor is greater than the high voltage reference value; and
in response to that the voltage signal of the charging capacitor is less than or equal to the high voltage reference value, turning on the charging circuit; in response to that the voltage signal of the charging capacitor is greater than the high voltage reference value, turning off the charging circuit.
